(19) United States
(12) Patent Application Publication
(10) Pub. No.: US 2015/0186597 A1
(43) Pub. Date: Jul. 2, 2015

(54) LINKAGE MAPPING PROCESS PROVIDING BOTANICAL PHENOTYPE TRANSLATION FOR PLANT-BASED CHEMICAL BY-PRODUCT DEVELOPMENT

(71) Applicant: Charles L. Buchanan, Houston, TX (US)

(72) Inventor: Charles L. Buchanan, Houston, TX (US)

(21) Appl. No.: 14/584,154

(22) Filed: Dec. 29, 2014

Related U.S. Application Data
(60) Provisional application No. 61/921,174, filed on Dec. 27, 2013.
(60) Provisional application No. 62/013,736, filed on Jun. 18, 2014.

(51) Int. Cl. G06F 19/18; G06F 19/24; C40B 30/02

(52) U.S. Cl. CPC G06F 19/18; C40B 30/02; G06F 19/24

(57) ABSTRACT

A linkage mapping process incorporating an RBF non-linear classifier pattern-matching approach for use in the genetic analysis and modification of botanical organisms by comparing infrared mass spectroscopy, isomeric-level quantitative chemical analysis patterns, with single-molecule real-time genetic and genomic isoform analysis sequence patterns to build a searchable pattern library of those phenotype patterns producing commercially desirable traits for directed selection of desirable attributes and identification of their associated phenotype patterns.

### CROSS-REFERENCE TO RELATED APPLICATIONS

The present application claims priority from Provisional Patent Application Ser. No. 61/921,174, filed on Dec. 27, 2013, and entitled “Linkage Mapping Process for Plant-based Pharmaceutical Development”, presently pending. The present application also claims priority from Provisional Patent Application Ser. No. 62/013,736, filed on Jun. 18, 2014, and entitled “Linkage Mapping Process Providing Botanical Phenotype Translation for Plant-based Chemical By-product Development”, presently pending.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to the field of non-zoological botanical organism selective breeding or genetic modification for commercially valuable functional improvements, including chemical, biofuel, and agribusiness production purposes. More particularly, the present invention relates to the integration of advanced chemical analysis technology with genetic analysis technology using the pattern recognition abilities of cognitive computing in a sequenced process to identify, analyze, and interpret patterns within the genetic code of organisms that are responsible for determining a broad range of functional attributes, including customizing chemical by-product output, enhanced photosynthesis and growing processes, increased yields, shorter growing cycles, improved nutrient metabolism and moisture conservation, as well as greater environmental hardiness and tolerance to pests, disease, and poor soil conditions.

2. Description of Related Art Including Information Disclosed Under 37 CFR 1.97 and 37 CFR 1.98.

Plant breeding has been practiced for thousands of years and allows for changing the genetic makeup of plants to produce desired functional results. Modern breeding of both plant and other botanical organisms like algae, fungi, bacteria, yeasts, and molds allows for the inclusion of commercially desirable traits. Genetic screening allows scanning the DNA of an organism to identify the genetic code of those organisms having desirable functional traits, or benefits of interest. The advent of functional genomic screening of the RNA and mRNA transcriptome now allows the identification of those plants with beneficial responses to environmental conditions as well. What is still missing is the ability to understand and characterize the genetic patterns, or phenotypes, which determine those functional, beneficial results. Modern genetic modification essentially involves changing the gene sequence wherein a gene or a number of genes are added to the genum of an organism in order to build a desired phenotype pattern that will produce the desired functional improvement in the organism. A gene or a number of genes can also be removed from, or replaced in, the genum of a botanical organism.

Various methods of plant breeding are used in modern times. A variety of techniques that now allow genetic modification of plants for functional improvement are also becoming commonplace, and as they are, the means of making these modifications are becoming more efficient and effective. The missing key to the efficient bioengineering of desired functional improvements in botanical organisms is still the ability to fully understand and characterize the relationship between the observed phenotype pattern in an organism's genetic code (both its DNA sequence and its protein transcripts that regulate gene expression) and the functional attributes they determine that are exhibited by that botanical organism.

In one currently popular method of genetic modification, a large and important group of plants (Dicotyledonous plants, which include many commercial plant species like tobacco and tomatoes), bacteria can be used to insert genetic construct implants into a plants genetic code. Agrobacterium is a genus of Gram-negative bacteria established by H. J. Conn that uses horizontal gene transfer to cause tumors in plants. Agrobacterium tumefaciens is the most commonly studied species in this genus. Agrobacterium is well known for its ability to transfer DNA between itself and plants, and for this reason it has become an important tool for genetic engineering. In 1983, Shilperoort et al., taught in U.S. Pat. No. 4,940,838A a process for the incorporation of foreign DNA into the genome of dicotyledonous plants. The invention relates to a process that incorporates foreign DNA into chromosomes of dicotyledonous plants by infecting the plants or incubating plant protoplasts with Agrobacterium bacteria, which contain one or more plasmids, wherein bacteria are used which contain at least one plasmid having the vir-region of a Ti (tumor inducing) plasmid but no T-region, and at least one other plasmid having a T-region with foreign DNA incorporated therein but no vir-region, as well as an Agrobacterium bacteria wherein at least one plasmid which has the vir-region of a Ti (tumor inducing) plasmid but no T-region and at least one other plasmid which has a wild type T-region with foreign DNA incorporated in it but no vir-region. Another common method involves the use of a gene gun (biolistic method), or microinjection.

In 1984 Sanford et al., taught in U.S. Pat. No. 4,945,050A how inert or biologically active particles are propelled at cells at a speed whereby the particles penetrate the surface of the cells and become incorporated into the interior of the cells. The process can be used to mark cells, or tissue, or to biochemically affect tissues or tissue in situ, as well as single cells in vitro. Apparatus for propelling the particles toward target cells or tissues are also disclosed. A method for releasing particles adhered to a rotor device is disclosed as well.

In 1998 Maliga et al., taught in U.S. Pat. No. 6,987,215B1 translation control elements and methodology for high-level protein expression in the plastids of higher plants. DNA constructs containing translational control elements are provided. These 5′ regulatory segments facilitate high level expression of transgenes introduced into the plastids of higher plants, allowing modification of gene expression control, and thereby it's response to environmental conditions.

One new method for producing genetically modified organisms that will work particularly well in conjunction with the present invention is the 3D Genetic Material Printer developed by Cambrian Genomics. This printer allows the digitally stored modified genetic coding of a hybrid plant bioengineered with this invention to be simply printed out in a DNA sequence for genetic modification of the organism. [The portfolio of related art taught from 2004 to 2011 include: Coherent electron junction scanning probe interference microscope, nanomanipulator and spectrometer with assembler and DNA sequencing applications—US 20070194225 A1; Sequencing of nucleic acids—US 20110008775 A1; Biological laser printing via indirect photon-biomaterial interactions—U.S. Pat. No. 7,875,324 B2; Biological laser printing via indirect photon-biomaterial interactions—US 20050018036 A1; Methods and apparatuses for mems-based recovery of sequence verified DNA—US 20140008223 A1; Methods and apparatuses for mems-based recovery of sequence verified DNA—WO 2013101773 A1].

Plants modified to produce pharmaceuticals by genetic modifications or plant breeding, also known as pharmacrops, are also frequently produced by splicing genetic material onto a common food crop, which offers the chance of dangerous inter-field contamination of food crops. Russell and Schlittler taught in 2001 in US 20030167531A1 a process for the production of proteins or polypeptides using genetically manipulated plants or plant cells, as well as to the genetically manipulated plants and plant cells per se (including parts of the genetically manipulated plants), the heterologous protein material (e.g., a protein, polypeptide and the like) which is produced with the aid of these genetically manipulated plants or plant cells, and the recombinant polynucleotides (DNA or RNA) that are used for the genetic manipulation. Their invention contemplated producing bioactive cytokines from plant host systems. These cytokines maybe any mammalian soluble protein or peptide which acts as a humoral regulator at the nano- to pico-molar concentration, and which either under normal or pathological conditions, modulate the functional activities of individual cells and tissues. Furthermore, the cytokines may also mediate interactions between cells directly and regulate processes taking place in the extracellular environment. They belong to the cytokine superfamilies', which include, but are not limited to: the Tumor Growth Factor-beta (TGF-beta) superfamily (comprising various TGF-beta isoforms, Activin A, Inhibins, Bone Morphogenetic Proteins (BMP), Decapentaplegic Protein (DPP), granulocyte colony stimulating factor (G-CSF), Growth Hormone (GH) (including human growth hormone (hGH)), Interferons (IFN), and Interleukins (IL)); the Platelet Derived Growth Factor (PDGF) superfamily (comprising VEGF); the Epidermal Growth Factor (EGF) superfamily (comprising EGF, TGF-alpha, Amphiregulin (AR), Betacellulin, and HB-EGF); the Vascular Epithelial Growth Factor (VEGF) family; Chemokines; and Fibroblast Growth factors (FGF).

These are powerful pharmacological agents which could prove dangerous if cross-pollination occurred with food crops being grown in nearby fields, or there was a failure to follow a ‘fallow season’ rule and a food crop was grown in a field the season following one where a transgenic crop was grown in that same field. What has been lacking to prevent such a tragic occurrence has been an accurate method to understand and interpret the functional genomic linkage between the genetic pattern of a botanical organism and the chemicals it produces. This will allow botanical organisms to be bioengineered with distinct features and obvious markers that will clearly differentiate food crops from non-food crops.

Genetically modified crops are very common presently. These crops or botanical organisms are modified for various reasons, including resistance to herbicides as well as tolerance of pests and diseases. Genetically modified botanical organism crops like plants, algae, microalgae, and molds are also used in the production of biofuels, pharmaceuticals, food crops, oils, waxes, resins, polymers, and are finding their way into other industrial and commercial applications every day. Most of these genetic modifications are accomplished by trial-and-error, either by searching for random, naturally-occurring, desirable mutations in a sample population; introducing stressors that produce an increase in random genetic mutations; or by splicing suspect genetic construct implants into a host botanical organism and monitoring the outcome for desired results. The present invention offers a systematic process integrating heretofore underutilized abilities in two current advanced analytical technologies with the cognitive computing technology of RBF non-linear classifiers to map genetic patterns to their functional results in botanical organisms.

Biofuel producers are currently heavily invested in research in an attempt to develop new genetic modifications in a variety of common organisms like red and green algae, white and brown molds, and also a variety of yeasts and bacteria, to introduce changes in their genetics offering commercial benefits such as bioengineering the lignin degradation pathway in organisms to produce specific custom hydrocarbon compounds, or improving hydrocarbon yields through a more efficient conversion of sugars to hydrocarbons, or delivering other functional and commercially valuable improvements. Biofuel production processes involving higher order plants can also incorporate other beneficial results like enhanced photosynthesis, a shorter growing cycle, higher yields, and lower growing costs.

In 1980 Axel et al., taught in U.S. Pat. No. 4,399,216A processes to insert DNA into eucaryotic cells to produce proteinaceous materials, and Nonomura taught in 1985 in U.S. Pat. No. 4,680,314A a process for producing a naturally-derived carotene and oil composition by direct extraction from algae without the use of petroleum-based solvents. Clayton et al., taught in 2008 in U.S. Pat. No. 8,512,998B2 a continuous process for recovering and concentrating valuable components from microalgae such as algal oils for use as biofuel feedstocks by utilizing agitation with solid particles, followed by adsorptive bubble separation.

Harvesting commercially valuable compounds using microbial and algal organisms has a long history, including genetic modification of microbial and algal organisms producing a variety of improvements in commercial products, including biofuels, chemical feedstocks, and nutritional products composed of oils, waxes, resins, and lipids. These have become increasingly commonplace, but a lack of understanding of the botanical organism's phenotype/analyte relationship has hampered the ability to cost-effectively bioengineer greater efficiencies and improve the ability to scale production to large quantities.

Moore and Benjamin taught in U.S. Pat. No. 3,280,502A the process for the preparation of lutein using an algal strain, and later Franklin et al., taught in U.S. Pat. No. 7,935,515B2 one of the early methods of developing recombinant microalgae cells for the production of novel oils [genus Prototheca comprising an exogenous fatty acyl-ACP thioesterase gene; makes biofuel feedstock triglyceride; algal oils with shorter chain length and a higher degree of saturation and without pigments]. Perhaps some of the most well-known genetically modified crops fall into the category of “Roundup Ready®”. These plants or seeds are produced by Monsanto and are resistive to the herbicide Roundup®, which is also produced by Monsanto. Roundup Ready® crops include corn, soybeans, alfalfa, canola, sugar beets and cotton.

U.S. Pat. No. 5,554,798, issued on Sep. 10, 1996 to Lundquist et al., is one of a number of patents which covered the Roundup Ready® corn plant. The '798 patent describes fertile glyphosate-resistant transgenic corn plants. Fertile transgenic Zea mays (corn) plants which stably express heterologous DNA which is heritable are provided along with a process for producing said plants. The preferred process comprises the microprojectile bombardment of friable embryogenic callus from the plant to be transformed. The process may be applicable to other graminaceous cereal plants which have not proven stably transformable by other techniques. U.S. Pat. Nos. 5,593,874, 5,641,876, 5,717,084, 5,728,925, 5,859,347, 6,025,545, 6,083,878, 6,825,400, 7,582,434, 8,273,959 and RE39247 are also part of the patent portfolio for Roundup Ready® corn plants.

Accurate functional genomic bioengineering would allow customization of a broad array of environmental responses by the plant to specific environmental conditions by selecting for those identified transgene regulatory segments. With the understanding of the functional genomic coding of a plant species and the ability to modify its high-level protein expression, it is possible to program its responses to rainfall; soil conditions; heat/cold; pests; as well as fungal, bacterial, and viral diseases. This would offer tremendous cost savings in the process of growing plants for commercial and agricultural purposes worldwide.

One of the more controversial common plants currently subject to genetic modification or plant breeding for medical purposes is cannabis, or marijuana. Cannabis is a genus of flowering plants that includes three putative varieties, Cannabis sativa, Cannabis indica, and Cannabis ruderalis (collectively referred to herein as cannabis). Cannabis is subject to modification for both recreational and medicinal usage. Medicinal usage of cannabis is becoming ever more popular in the United States, as more and more states legalize or decriminalize the usage of cannabis for medicinal purposes. While still primarily taken in ‘herbal remedy’ form today, research is actively underway to isolate the active components for pharmaceutical preparations but that is complicated by the fact that these extracts being studied, known as analytes, must be analyzed both for their molecular composition (for the 85 possible cannabinoid molecules as well as other potentially therapeutic molecules that could be present), and also for which of the possibly 100+ isomers that are possible for each of those molecules are present. These isomers are now able to be identified by their unique signature, determined by detecting the position of its carbon ring using infrared mass spectroscopy.

This technology today is designed, and primarily used, to determine the presence or absence of a specific target isomer, as in investigations for the presence of illegal drugs or toxic contaminants, but if the analysis pattern produced of the extracted analyte is viewed in total it is in effect a pattern that fully identifies and quantifies the components contained in the analyte, which not only identifies and quantifies the molecules present, but also identifies their relative carbon-ring positions, which further identifies the relative quantity of the individual isomers of these molecules that are present. Thus, this complex pattern completely and accurately describes the analyte(s) being tested and thereby completely and accurately describes the botanical organism's chemical by-product composition.

A pattern completely describing an analyte at the isomeric level also defines its functional attributes, describing exactly what it will do both in important chemical reactions needed in biofuels, biomass power generation, chemical feedstocks, and other industrial applications, but this isomeric-level granularity is especially important in medical and nutritional products because we react to food, nutritional supplements, and medicines we consume based on which isomers of which molecule we ingest. Largely, therapeutic effects of medicines are produced when a desired isomer in the pharmaceutical compound bonds with a matching receptor in the body, similar to a ‘lock and key’ mechanism. Other undesired isomers of that molecule, if present, may similarly bond with that same receptor, but will produce other, potentially undesirable results. This is the suspected root cause of many allergic reactions and pharmaceutical side effects, and the reason for the necessity of a ‘batch’ process in pharmaceutical production.

For example, cannabis contains a diverse class of chemical compounds known as cannabinoids. One notable cannabinoid is Tetrahydrocannabinol (THC). THC (specifically its main isomer (−)-trans-Δ9-tetrahydrocannabinol) is a primary psychoactive component of cannabis and the source of one of the euphoric effects experienced when cannabis is consumed, but the wide variety of reported effects are attributed to the ‘entourage effect’ of the combination of one or more other isomers of THC, or possibly various isomers of other cannabinoids as well.

Aside from THC, cannabis contains eighty-five other cannabinoids, each of them potentially configured in many isomeric forms, some with as many as 146 configurations, each different, and often producing different effects or no effect at all. Cannabidiol (CBD) is also another major cannabinoid constituent of the cannabis plant. It has been well established that the different cannabinoids which have been isolated from cannabis have different effects on the user. The factor differentiating these effects and their potency is which isomers of which cannabinoids are present in what quantities in the oil produced by the plant, and because the numbers of possible combinations are vast, completely isolating production to a single isomer through genetics has not been possible, and separating a compound at the isomeric level physically after extraction is not economically feasible.

An isomer is one of two or more compounds having identical molecular formula and weight, but differing in the arrangement or configuration of the atoms. Isomers of the same molecule often show different chemical reactions with other substances that are also isomers. Since many molecules in the bodies of living beings are also isomers themselves, there is often a marked difference in the effects of two isomers on living beings. In drugs, for example, often only one of a molecule's isomers is responsible for the desired physiologic effects, while other isomers of that molecule may be less active, inactive, or sometimes even responsible for adverse effects, including extremely toxic ones.

These isomers are so chemically similar that there is currently no way to physically separate them with a chemical process, so they must be included in, or removed from, the desired mix (at the desired concentration) by selective breeding or genetic modification within the botanical organism feedstock prior to extraction. Until recently, any attempt to do even the simplest quantitative analysis at the isomeric level was extremely difficult, time-consuming, and incredibly expensive, with only mixed results, while requiring large capital investment in both equipment and lab time.

Each of the eighty-five or more cannabinoids from cannabis can have a number of isomers and stereo isomers, which may have different effects and efficacy. In addition to the three species of cannabis plants that produced cannabinoids, other plants like Echinacea, acmella, heliachrysum, and radula also produce cannabinoid isomers and offer similar promise medically, if the isomers with therapeutic effects could only be identified, isolated and concentrated.

Cannabinoids interact with membrane bond receptors CB1 and CB2. CB1 receptors, which are most commonly found in the brain, are responsible for the euphoric and anticonvulsive effects of cannabis. CB2, on the other hand, is found mostly in the immune system, and cannabinoid attachment on the CB2 receptor is thought to be responsible for the anti-inflammatory and possibly other therapeutic effects. Newer studies suggest other receptors may be located throughout the body.

CBD has been shown to possibly relieve convulsion, inflammation, anxiety and nausea effects, mostly at CB2 receptors. Relief of nausea is one of the primary reasons why cannabis is used for patients undergoing cancer treatment, and why it serves as an appetite stimulant due to the relief of nausea. Further, some research has shown that CBD in sufficient concentrations may also “turn off” the activity of the LD1 gene, which is the gene expression responsible for metastasis in breast cancer and many other types of cancers. It is also suspected to restrict the oxygen uptake of tumor-producing cancer cells, essentially suffocating them, while not affecting healthy cells.

Different strains of a pharmacrop used to produce a pharmaceutical product may produce different isomers of the active molecule being extracted. For example, cannabis plants produce eighty-six different cannabinoids (and potentially even more different isomers than that are possible with many of these cannabinoids), which influence and determine the medicinal effects from the usage of cannabis. Some cannabinoids are also antagonistic of others. For example, THCV attenuates the psychoactive effects of THC. It is also known that in many medicines derived from plants, the same plant producing the therapeutic isomer frequently also produces one or more antagonist isomers that either nullify or attenuate the therapeutic effect or have even more serious side effects.

Perhaps one of the most notable examples of isomers from a particular compound causing adverse effects involved the 1970's birth defect crisis associated with women taking the drug Thalidomide during pregnancy. A change in plant feedstock to a different, though almost identical variety of the same species resulted in a different mix of isomers of the Thalidomide molecule. The previously unknown isomer caused horrific birth defects in the children these women were carrying.

As noted above, cannabis has been the subject of vigorous selective breeding, and with legalization will likely be the target of increased genetic modification efforts. For example, cannabis strains used to produce hemp may be bred so that they are low in THC, the psychoactive chemical within the cannabis plant, but whose fibers exhibit a comparatively high strength-to-weight ratio. Similarly, strains which are used medicinally are often bred specifically for high CBD content. Conversely, strains used exclusively for recreational purposes are bred to contain high amounts of THC for a greater psychoactive or euphoric affect. Cannabinoids can be administered by smoking, vaporizing, oral ingestion, transdermal patch, intravenous injection, sublingual absorption, or rectal suppository. Most cannabinoids are then metabolized in the liver.

So that the cannabinoids can be ingested in manners other than smoking, vaporizing or oral ingestion, the cannabinoids are commonly separated from the plant. This often is accomplished through the use of organic solvents such as hydrocarbons and alcohols, or through mechanical means such as liquid CO₂.

Liquid chromatography-mass spectrometry (LC-MS) is commonly used to identify the chemical composition of a sample (analyte) or plant. Gas chromatography-mass spectrometry (GC-MS) is also used. However, the use of LC-MS and GC-MS alone do not allow for the identification of compounds at the isomeric level. LC-MS is commonly used in drug and other chemical production testing at different stages of the development including quality control.

Recently, new technology has become available which would allow for relatively easy quantitative analysis of compounds at the isomeric level. The DiscovIR system produced by Spectra Analysis, Inc. described in U.S. Pat. No. 7,590,196B2 [Chiral mixture detection system using double reference lock-in detector], combines a High Performance Liquid Chromatograph (HPLC) with infrared spectra analysis to produce a isomeric-level molecular analysis of an analyte in order to detect the presence of a specific targeted isomer within a complex organic compound.

In 1956 Dawson, Jr. taught multiple column gas chromatography for chemical analysis in U.S. Pat. No. 3,234,779A, and later in 1956 Tracht teaches an improved methodology and apparatus for gas chromatography. In 1962, William teaches liquid chromatography in U.S. Pat. No. 3,292,420A. HPLC, or High Performance Liquid Chromatography, is a separation technique in which a chemical sample is forced by a liquid at high pressure (the mobile phase) through a column that is packed with a stationary phase composed of irregularly or spherically shaped particles, a porous monolithic layer, or a porous membrane. The various constituents of the mixture travel at different speeds, causing them to separate. The HP-LC delivers this column eluent to the infrared mass spectroscope (i.e. Spectra Analysis' DiscovIR Test Station) and it is direct deposited in eluted peaks on a moving, cryogenically cooled IR-transparent sample disc as an infrared beam passes through each concentrated spot and the detector automatically collects the spectral data.

This technology is traditionally used to search for the presence of a specific analyte as in chemical component identification like illegal or toxic substances, along with chemical troubleshooting and failure analysis. Instead, we use the entire dataset of the analyte analysis as one complete pattern, a chemical inventory that accurately and fully describes and identifies the complete, complex organic chemical compound produced by that individual botanical organism, at the isomeric level. We compare this chemical analysis pattern from the mass spec with an equally accurate, equally granular genetic pattern that describes the botanical organism's entire genetic profile, a pattern that can include both the botanical organism's genetic sequence and genomic transcript data.

Single Molecule Real Time Sequencing, also known as SMRT, is a parallelized single molecule DNA sequencing by synthesis technology, the process of determining the precise order of nucleotides within a DNA molecule [developed by Pacific Biosciences (previously named Nanofluidics, Inc.)]. In U.S. Pat. No. 8,501,405B2, filed in 2010 [real-time sequencing methods and systems], Korlach et al., teaches compositions, methods, and systems for performing single-molecule, real-time analysis of a variety of different biological reactions. Other related patents in the Pacific Biosciences of California portfolio include U.S. Pat. No. 8,501,406, U.S. Pat. No. 8,609,421, U.S. Pat. No. 8,389,676, U.S. Pat. No. 8,058,031, U.S. Pat. No. 8,420,366, U.S. Pat. No. 8,053,742, U.S. Pat. No. 8,367,159, U.S. Pat. No. 8,628,940, and U.S. Pat. No. 8,795,961. It includes any method or technology that is used to determine the order of the four bases-adenine, guanine, cytosine, and thymine-in a strand of DNA. Knowledge of DNA sequences has become indispensable for basic biological research, and in numerous applied fields such as medical diagnostics, forensic biology, and virology.

In 2008, Heiner et al., taught in U.S. Pat. No. 8,003,330B2 a method for error-free amplification of DNA for clonal sequencing. Provided are methods of producing low-copy-number circularized nucleic acid variants that can be distributed to reaction volumes. The methods include providing a template nucleic acid; producing a population of clonal nucleic acids from the template nucleic acid; generating a set of partially overlapping nucleic acid fragments from the population of clonal nucleic acids; circularizing the partially overlapping nucleic acid fragments to produce circularized nucleic acid variants; and aliquotting the circularized nucleic acid variants into reaction volumes. Related compositions of nucleic acid templates are also provided.

This was followed by a series of other Pacific Biosciences of California patents from 2009 to 2013 involving methodologies for nucleic acid sample prep, analysis, and sequencing, including U.S. Pat. Nos. 8,153,375B2, 8,236,499B2, 8,501,405B2, 8,609,421B2, U.S. Pat. No. 8,455,193B2, and U.S. Pat. No. 8,535,886B2.

Using the long reads generated by SMRT sequencing, the isoform sequencing method provides reads that span entire transcript isoforms, from the 5′ end to the 3′ polyA-tail. It is now possible to directly sequence full-length transcripts ranging up to 10 kb. Generation of accurate, full-length transcript sequences greatly simplifies this analysis by eliminating the need for transcript reconstruction to infer isoforms using error-prone assembly of short RNA sequence reads. Understanding the complete representation of a sample's gene isoforms increases the sensitivity and specificity of quantitative functional genomics studies. Isoform sequencing also provides information to efficiently detect or validate novel gene fusions, and has also been used to determine allele-specific isoform expression.

In 2000, Korlach et al., taught in U.S. Pat. No. 7,056,661B2 a method for sequencing nucleic acid molecules. The advent of rapid DNA sequencing methods has greatly accelerated biological and medical research and discovery. In 2002, Levene et al., taught in U.S. Pat. No. 6,917,726B2 of zero-mode clad waveguides for performing spectroscopy with confined effective observation volumes, enabling a method and an apparatus for analysis of an analyte. Single molecule real time sequencing utilizes the zero-mode-waveguide (ZMW), an optical waveguide that guides light energy into a small 10-12 liter volume for rapid parallel sensing in gene sequencing applications.

A single DNA polymerase enzyme is affixed at the bottom of a ZMW with a single molecule of DNA as a template. The ZMW is a structure that illuminates a sample volume small enough to observe only a single nucleotide of DNA being incorporated by DNA polymerase. Each of the four DNA bases is attached to one of four different fluorescent dyes. When a nucleotide is incorporated by the DNA polymerase, the fluorescent tag is cleaved off and diffuses out of the observation area of the ZMW where its fluorescence is no longer observable. A detector detects and identifies the fluorescent signal of the nucleotide base by the fluorescence of that specific dye.

In 1992, M. Holler et al., of Intel Corp published in conjunction with Nestor and DARPA, “A High Performance Adaptive Classifier using Radial Basis Functions”, and submitted it to the Government Microcircuit Applications Conference in Las Vegas, Nev., wherein a 1024 neuron RBF/RCE VLSI hardware component was proposed. This initiated a development process, and from 1993 to 2010 Intel/Nestor with DARPA assistance co-developed the NI1000, utilizing a RBF non-linear classifier. Around the same time, IBM validates and patents a similar architecture with a project also utilizing a RBF non-linear classifier. [U.S. Pat. No. 5,717,832 Improved neuron circuit architecture, U.S. Pat. No. 5,710,869—Daisy chain circuit for serial connection of neuron circuits, U.S. Pat. No. 5,701,397—Circuit for pre-charging a free neuron circuit, U.S. Pat. No. 5,740,326—Circuit for searching/sorting data in neural networks].

In 2011, CogniMem Technologies Inc. is established to further develop this technology for the next generation of VLSI ASIC processors targeting RBF non-linear classifier usage models in cognitive computing systems for applications like image recognition, pattern matching, language translation, and genetic analysis.

Utilizing this massively parallel processing approach in conjunction with functional bioinformatics methodologies (including artificial intelligence, Bayesian & Boolean networks and network inference tools), along with the use of functional genomics data, chemical characterization, and leading edge computational biology, this invention will serve as an analytic platform for discovery and improvement that will change the way business is done in agricultural biology, renewable energy sources, textiles and nutritional health.

It is an object of the present invention to utilize infrared spectra analysis technology in conjunction with advanced genetic analysis and RBF non-linear classifier technology so as to produce a pattern map linking genetic patterns to the functional attributes of botanical organisms that will allow the accurate genetic modification of botanical organisms generating desired functional attributes, whether that's producing pure isomers to extract for medicinal, therapeutic, nutritional, or other industrial uses, or its engineering botanical organism species for optimal an response to environmental growing conditions.

It is another object of the present invention to provide a linkage mapping process which allows for the identification and genetic isolation of a specific isomer to determine its medicinal effect, shortening pharmaceutical development time to clinical-trial-ready status and allowing directed genetic concentration of desired effect(s).

It is another object of the present invention to provide a linkage mapping process which allows the identification, for removal, of unwanted antagonistic or harmful isomers from a pharmaceutical feedstock plant, or other commercially grown organism, providing directed, concentrated benefits and reduced side effects.

It is another object of the present invention to provide a linkage mapping process which allows for the production of medicines and other chemical compounds of high potency and purity from both botanical organisms.

It is yet another object of the present invention to provide a linkage mapping process which allows for the rapid and accurate directed design and production of new hybrid organisms incorporating beneficial traits allowing lower production costs and higher yields for commercial crops like biofuels, fruits, vegetables, grains, and chemical feedstocks.

It is yet another object of the present invention to provide a linkage mapping process which allows for the accurate, programmed concentration and differentiation of desired functional traits and environmental responses, including increased tolerance to drought and other climatic and environmental extremes, as well as engineered responses to pests, diseases, and weed encroachment.

It is yet another object of the present invention to provide a linkage mapping process which allows for the directed development of botanical organism genetics with novel attributes not found in nature, including but not limited to: new flavor and nutritional profiles for botanical organism-based food and feed products; timber products with custom grains and colors, new properties of fire, insect, and moisture resistance; organisms that can grow in extremely harsh environments on other planets and convert marginal atmospheres to oxygen-rich ones allowing future human habitation, or provide other agricultural terraforming applications; textiles, rope, and fiber products with various beneficial functional advantages: like improved absorption and wicking, greater insulation, strength/durability, appearance; moisture resistance, and anti-microbial action.

These and other objects and advantages of the present invention will become apparent from a reading of the attached specification and appended claims.

### BRIEF SUMMARY OF THE INVENTION

The present invention is a linkage mapping process to characterize patterns in genetic code that will allow accurate functional modification to improve botanical organisms like botanical organisms, algae, fungi, molds, bacteria, and yeasts for agricultural, commercial, and industrial applications. The process initially involves molecular analysis of their analyte extracts at the isomeric level. This analysis is done using high performance liquid chromatography paired with infrared spectra technology. Statistical occurrences of each specific identified isomer of the extract produced by the organism are correlated with the phenotype patterns of that same organism produced through advanced genetic analysis. The genetic analysis used must produce an extremely accurate and granular pattern using a high-performance gene sequencer. Using advanced computational image recognition and pattern matching systems, the statistical correlations of these patterns are analyzed. These first steps of the process establish an isomer-gene link and characterize these phenotype/analyte pattern relationships.

Next, targeted selective breeding or genetic modification is used to grow botanical organisms that will consistently produce a specific pre-determined mix of chemicals as their by-product that can be customized beyond the molecular level to even select for desired specific isomers of the molecules produced, introducing unparalleled levels of chemical purity and potency for isomeric-sensitive applications like pharmaceuticals and healthcare products.

For example, the process could involve production of medical cannabis plants, or other pharmacrop species like Echinacea, which produce cannabinoids. By being able to clinically test an analyte containing only specifically selected isomers, it can be determined which isomers produce certain positive and negative effects on users. The present invention allows for the genetic isolation and concentration of the selected isomers for testing to identify those isomers having the desired medical affects.

Botanical organisms are genetically modified so as to isolate the isomer or isomers having the desired functional affect, and eliminate those extraneous and undesired isomers. The analyte containing the pure, concentrated desired isomers can then be optionally separated easily as a simple extract from the bioengineered botanical organism to accurately produce safe, but very potent medicines or other commercial and industrial chemical products.

Similarly, this process can be used to characterize, and subsequently optimize, a wide variety of valuable functional botanical organism attributes, including the aforementioned analyte optimization, across a wide variety of industries and applications, from biofuels to agribusiness to chemical feedstocks to timber and wood products to terraforming. These would also include the introduction of novel traits like environmental hardiness, appearance, life cycle attributes and other responses programmed in the organism's isoform sequence,

One embodiment of the present invention is a linkage mapping process for use in the genetic modification of botanical organisms comprising the following steps: obtaining a genetic sample from an organism; obtaining an analyte sample from said organism; conducting a chemical analysis on said analyte sample using one or more of an infrared mass spectrometry machine and a high performance liquid chromatography machine so as to create a chemical analysis dataset; conducting a genetic analysis on the genetic sample using a gene sequencer machine so as to obtain a DNA and isoform pattern dataset; identifying a dynamic genome sequence are of said organism; correlating patterns of said chemical analysis dataset and said DNA and isoform pattern dataset; and building a searchable pattern library based on the correlated patterns. The linkage mapping may further include the step of determining a desired analyte mix and related phenotype patterns.

In one embodiment of the present invention, the process further includes the steps of selecting phenotype patterns to isolate the desired analyte mix to grow for functional testing; and printing or otherwise producing a genetic sequence incorporating phenotype modifications for insertion. The organism may be a plurality of organisms of the same species, specifically a non-zoological botanical species, like plants, algae, fungi, molds, yeasts, and bacteria.

In the present invention, the DNA and isoform pattern dataset include a DNA pattern dataset and a separate isoform sequence dataset overlayed with said DNA pattern dataset. In the present invention, an environmental growing conditions dataset containing environmental data of growing conditions experienced by the organism may be created, and a sample record dataset may be created containing the growing condition dataset, the chemical analysis dataset and the DNA and isoform pattern dataset.

In the present invention, the step of correlating patterns may be conducted with an artificial intelligence system. The artificial intelligence system may utilize RBF non-linear classifier technology.

In the present invention, preferably the chemical analysis is conducted at an isomeric level.

The present invention is also a process for identifying genetic code for functional botanical organism attributes including the following steps: obtaining a genetic sample from an organism; obtaining an analyte sample from the organism; conducting a chemical analysis on the analyte sample using one or more of an infrared mass spectrometry machine and a high performance liquid chromatography machine so as to create a chemical analysis dataset; conducting a genetic analysis on the genetic sample using a gene sequencer machine so as to obtain a DNA dataset and an isoform pattern dataset; creating a growing condition dataset containing environmental conditions data of the organism; creating a sample record dataset comprising the chemical analysis dataset and the DNA dataset and the isoform pattern dataset and the growing condition dataset; identifying a dynamic genome sequence area of the organism; correlating patterns of the sample record dataset; and building a searchable pattern library based on the correlated patterns. The searchable pattern library is utilized to create a genetic sequence suitable for producing a desired isomer and corresponding functional attribute.

The present invention is also a process for creating a botanical organism having a desirable functional attribute including the following steps: obtaining genetic samples from a plurality of organisms of the same species; obtaining analyte samples from the plurality of organisms; conducting a chemical analysis on the analyte samples using one or more of an infrared mass spectrometry machine and a high performance liquid chromatography machine so as to create a chemical analysis dataset, the chemical analysis dataset comprising makeup of the organisms at an isomeric level; conducting a genetic analysis on the genetic samples using a gene sequencer machine so as to obtain a DNA and isoform pattern dataset; identifying a dynamic genome sequence are of said organism; correlating patterns of the chemical analysis dataset and the DNA and isoform pattern dataset; building a searchable pattern library based on the correlated patterns; determining a desired analyte mix and related phenotype patterns; selecting phenotype patterns to isolate desired analyte to grow for functional testing; and printing a genetic sequence incorporating phenotype modifications for insertion or other methods of genetic modification.

The foregoing Section is intended to describe, in generality, the preferred embodiment of the present invention. It is understood that modifications to this preferred embodiment can be made within the scope of the present invention. As such, this Section should not to be construed, in any way, as limiting of the scope of the present invention.

### BRIEF DESCRIPTION OF THE DRAWINGS

FIG. 1 is a flow chart detailing the process of the present invention.

### DETAILED DESCRIPTION OF THE INVENTION

Selective breeding, and more recently induced genetic modification, has produced a variety of important functional improvements across a wide range of botanical species grown for commercial, agricultural, and industrial purposes. The approach to accomplish this uses a largely trial-and-error methodology whereby large botanical organism populations are monitored, with or without techniques to accelerate genetic mutations, for functionally improved, useful traits. This essentially random process is very time-consuming and labor intensive, and because of that, very costly. It is also very inaccurate, and for that reason some of these processes may pose potential dangers for contamination of adjacent food crop production and thereby could pose a danger to public health.

This linkage mapping process for developing function genetic improvements in commercially grown botanical organisms of the present invention attempts to solve this problem, and is composed of five essential steps.

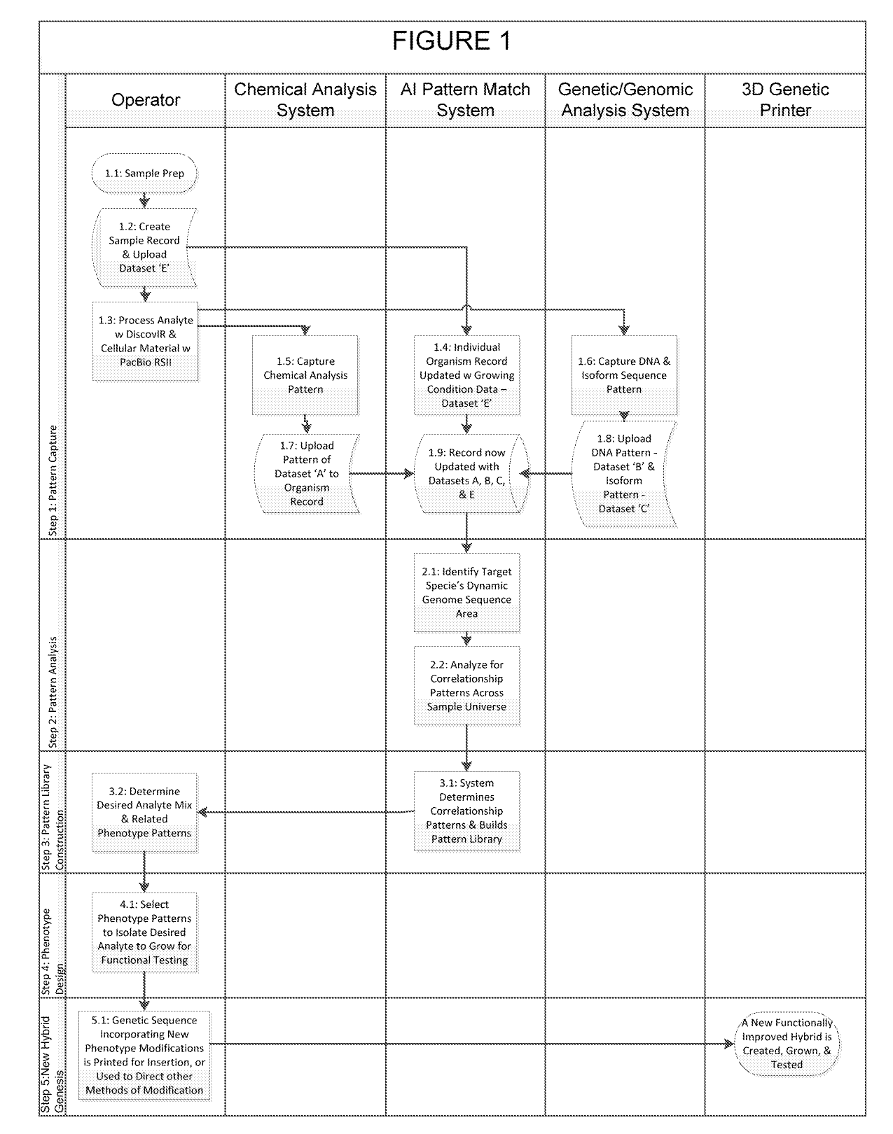

Referring to FIG. 1, Step One of the process is Pattern Capture. In Step 1.1, both analyte and genetic material samples are taken from a statistically relevant number of individual organisms of the target species to be genetically mapped for functional properties. Preferably, the organism is a non-zoological botanical organism like algae, fungi, plants, bacteria, molds, or yeasts.

A unique sample record is created in the database in Step 1.2 for each organism being sampled. To map only the DNA phenotypes, and not the isoform sequence including transcriptome annotations and assemblies that determine each organism's programmed environmental responses, the sample organisms will be grown with identical environmental conditions to remove that as a variable and only the DNA sequence, Dataset ‘B’, would be required as the genetic pattern to match.

Alternatively, if the sampled organisms are grown under a variety of monitored and logged environmental conditions, these are uploaded during this step, and a more complex pattern can be utilized that will account for, and incorporate the botanical organisms genetically programmed environmental responses as well.

This is done by adding the functional genomics analysis pattern of its full RNA transcript analysis, or isoform sequence pattern, Dataset ‘C’, as an overlay to the DNA sequence, Dataset ‘B’, and using that combined pattern, Dataset ‘D’, as the genetic profile pattern that incorporates both its DNA sequence and its RNA and mRNA transcriptome, defining its functional genomic characteristics, and thereby determining its response to environmental conditions. These patterns, when analyzed, will exhibit specific and unique patterns describing that organism in both genetic and isoform sequence analysis results. These patterns are like blueprints, one identifying the genetic code that fully defines and describes that organism, and the other completely describing the organism's programmed environmental response mechanisms.

The isomeric-level quantitative chemical analysis of the analyte extracted from the target botanical organism is carried out in Steps 1.3 and 1.5 by using a combination of IRMS (infrared mass spectrometry) and High Performance Liquid Chromatography such as the DiscovIR Test Station mentioned hereinabove. This technology allows for identification of the various isomers of chemical molecules produced as a by-product of the organism.

Concurrently, in Step 1.4, the relevant monitored environmental growing condition history experienced by the organism, Dataset ‘E’, is uploaded to the Sample Record.

At that same time in Step 1.5, an isomer library searching program, is built using the results of the isomeric analysis of Step 1.3 identifying the isomeric makeup of the by-products produced by each of the plurality of strains of the individual organisms. This allows for the automated identification of each specific isomer present in the analyte, or analytes.

This chemical analysis system is generally used to determine the presence or absence of a specific isomer within a complex organic compound, most commonly looking for a toxic or illegal substance, or one that might indicate a point-of-failure for trouble-shooting purposes, but we will use the entire pattern, Dataset ‘A’, as a digital, isomeric-level, unique chemical profile pattern that fully describes and defines the entire targeted portion of the chemical by-product extract taken from the sample organism.

In Step 1.6, the genetic and genomic analysis portion of the first step, which can be carried out simultaneously with Steps 1.4 and 1.5, involves genetic testing of the plurality of strains of each targeted botanical organisms genetic material. The genetic analysis is carried out by a gene sequencer like the Pacific Biosciences PacBio RSII, and the resulting DNA sequence pattern is recorded, Dataset ‘B’. It is essential that the genetic analysis used must provide near 100% accuracy, have the ability to do single molecule reads, and if environmental growing condition variables are involved, it must also have isoform sequencing capabilities.

Dataset ‘B’ describes the individual DNA sequence of each sample taken from the plurality of strains of the target species. The sampled organism's resulting DNA sequence pattern contains the genetic code necessary to re-create, or clone, itself. Common usage of this technology allows detection of the presence or absence of specific phenotypes for a variety of applications, including medical diagnostics, is also often used as a total pattern, but only to match forensic DNA for identification purposes. Rather than using this sequence data to search for a specific gene for diagnostic purposes or as a genetic fingerprint for identification, we use the entire DNA sequence pattern as a ‘cloning blueprint’ that describes how to build that botanical organism.

Dataset ‘C’ is the pattern that represents the functional genomic sequence of the botanical organism, also known as its isoform sequence, recording it's RNA/mRNA transcriptome's assemblies and annotations, and it can also be produced at that same time during Step 1.6, by the PacBio RSII, or similarly-capable genetic sequencer, to characterize the genomic patterns in the botanical organism's RNA and mRNA transcriptome that define its response to a variety of environmental variables, including soil conditions, rainfall, sunlight, heat/cold, and resistance to disease and pests. This pattern, Dataset ‘C’, used as an overlay to the DNA sequence pattern, Dataset ‘B’, accounts for the botanical organisms responses to its environmental conditions, and is particularly useful when the sample organisms are not grown in a controlled static environment.

In Step 1.7, the Chemical Analysis Pattern, Dataset ‘A’, produced from the extracted analyte, or analytes, is uploaded to its specific Sample Record field.

Concurrently, the DNA Sequence Pattern, Dataset ‘B’, and the Isoform Sequence Pattern, Dataset ‘C’, are uploaded to their specific Sample Record fields.

If environmental growing condition variables are available and being used, Dataset ‘B’ and Dataset Pattern ‘C’ are combined as overlays and used as the Genetic Analysis Pattern, Dataset Pattern ‘D’, in comparison with the Chemical Analysis Pattern ‘A’ for that organism.

By Step 1.9, the organism's Chemical and Genetic Patterns have been captured and its Sample Record is complete. It's now time to identify the target species sequence portions that change from individual to individual within that species, and characterize those relationships.

In Step Two, Pattern Analysis, we begin the preliminary process necessary to characterize the linkage(s) between phenotype patterns and the resulting analyte(s) produced, or other functional abilities the phenotype pattern in question determines. Using pattern matching and network inference technology of artificial intelligence systems like one based on the RBF non-linear classifier technology of CogniMem CM1K ASIC, we will compare how each individual botanical organism sample's genetic analysis pattern and its quantitative chemical analysis pattern correlate with each other across a large number of samples taken within that botanical organism species. We begin by identifying the area of the genome that changes from individual sample to sample within that species, and focus on pattern correlations within that dynamic area of the genome.

In Step 2.1, we compare all the Genetic Patterns observed across all Datasets ‘D’ (or ‘B’ without environmental variables) with each other, and identify that dynamic portion of the genetic code that changes from individual to individual within the species' genome, and also compile an inventory of observed molecules and their isomers that are potentially found as analytes in the extracts of their by-products within the target species, and select those of interest for development.

Focusing on these areas of interest within these two patterns, in Step 2.2, we compare and analyze for potential relationships between the Genetic and Chemical Analysis Patterns for each individual botanical organism tested. Using a combination of advanced computational processes, including the aforementioned high-performance, advanced classifier technology running Boolean, Bayesian, and network inference approaches to provide image recognition, pattern matching, and statistical analysis of their occurrences in the observed sample universe, the system develops the ability to characterize the relationship between the observed genetic and chemical patterns. This computer analysis of the correlation of how each botanical organism samples phenotype pattern and analyte pattern occurs across a statistically relevant sampling of the target species for a large enough universe of that botanical organism's available varieties to allow each distinct isomer that is possible for that botanical organism to produce to be associated with the specific genetic phenotype that determined the botanical organism's production of that isomer.

In the Third Step of the process, Pattern Library Construction, we use these pattern correlations in Step 3.1 to construct a database library of phenotype patterns and characterize how they determine chemical by-product and other functional attributes within the target species as observed in nature. When a phenotype/isomer association is identified its characteristics are saved to the genome's database in a Pattern Library in Step 3.1, so it can be automatically identified and described by the system the next time it is encountered. With the chemically functional DNA phenotype patterns identified and understood, we can also incorporate the isoform sequence pattern as an overlay to understand and design functional improvements to the botanical organism's genomic transcriptome that determine the botanical organism's responses to environmental conditions.

In Step 3.2, the desired by-product output or other desired functional characteristic is determined from those possible options available, either phenotype patterns with desirable functional features captured from within the identified functional phenotype pattern library of that sampled organism's mapped genome, or optionally, a phenotype pattern captured from another species with observed desirable functional features can be added to the target organism's genome.

In the Fourth Step of the process, Phenotype Design, the desired functional capabilities can be programmed into the new genome by digitally combining the phenotype patterns with the best functional attributes. With a new digitally bioengineered organism now constructed and saved to digital storage, we can proceed to generation of the physical organism.

In the Fifth Step of the process, New Hybrid Genesis, the newly designed organism is created using one of several common genetic modification techniques. Or, alternately this knowledge can be used to direct selective breeding campaigns. In the preferred embodiment, with the emergence of new 3D DNA printing, an optimized genome with any customized mix of attributes would simply be selected from the attributes possible within that species, and then printed on a 3D DNA Printer. This new genetic material can be inserted using one of the aforementioned techniques, including the use of agrobacteria used to modify dicotyledonous plants, or one of the other aforementioned means of inserting genetic constructs into a target organism.

In the case of pharmaceutical development, once the isomers have been identified and isolated, an additional step of the process can proceed. In the additional step of the pharmacrop development process, organisms are first genetically modified to isolate and concentrate specific targeted isomers for clinical testing to determine which ones are therapeutically effective in order to determine the exact desired mix of medically-effective isomers of the active molecule(s), while excluding those that dilute the medication or produce unwanted side effects. Once the desired medically effective mix of isomers of the molecule(s) is determined, the organism's genetics can be modified to produce a new hybrid organism that will produce that specific chemical mix as a life-cycle by-product.

By understanding how the phenotype pattern determines the production of each isomer, the process of the present invention allows for targeted selective breeding within a single growing cycle. The present invention also allows for identifying, understanding, and then inserting those phenotypes determined to produce the specific isomer(s) desired, and removing those phenotypes that produce an isomer that either dilutes the medicinal effect by blocking the necessary receptor or worse, produces one or more unwanted side effects.

Many commercial food crops, along with some pharmacrops like cannabis, are dicotyledonous. This allows the use of an agrobacteria approach in the final step, instead of the much more expensive proton gun technique, for genetic modification. By incorporating this invention's ability to characterize the phenotype that determines the desired functional attributes of an organism, there is no need for the currently common, cumbersome techniques like Marker Assisted Selection used by today's agribusiness companies engaging in genetic modification for pest-resistant, pesticide-resistant, herbicide-resistant, or similar functional traits.

Emerging technologies in 3D DNA printing like those mentioned earlier will allow the digitally improved genetics resulting from this invention to be simply printed, which will make this invention very easy and inexpensive to incorporate into existing genetic development programs.

The present invention allows for the introduction of the desired phenotypes directly into new hybrid strains of all commercially grown botanical organisms, and thereby isolate, concentrate and as desired, couple commercially valuable custom effects and functional improvements within organisms very quickly and accurately. A hybrid organism created can offer novel attributes for commercial and industrial uses not commonly found in that species.

It can also incorporate functional genomic programming of the genomic assembly and annotation process using the new third-generation isoform sequence analysis capabilities, so it will also provide for the understanding, and subsequent re-engineering of a botanical organism's functional genome such that an organism's response to environmental conditions can also be controlled, providing improved response to soil, light, temperature, and drought conditions, automating responses like producing their own natural pesticides and herbicides when needed, or even programming it to recognize a pest species attacking it and release the specific pheromone that will attract the natural predators of that pest.

The foregoing disclosure and description of the invention is illustrative and explanatory thereof. Various changes in the details of the illustrated construction can be made within the scope of the appended claims without departing from the true spirit of the invention.

I claim:

1. A linkage mapping process for use in the genetic modification of botanical organisms comprising the following steps:
obtaining a genetic sample from an organism;
obtaining an analyte sample from said organism;
conducting a chemical analysis on said analyte sample using one or more of an infrared mass spectrometry machine and a high performance liquid chromatography machine so as to create a chemical analysis dataset;
conducting a genetic analysis on said genetic sample using a gene sequencer machine so as to obtain a DNA and isoform pattern dataset;
identifying a dynamic genome sequence are of said organism;
correlating patterns of said chemical analysis dataset and said DNA and isoform pattern dataset; and
building a searchable pattern library based on the correlated patterns.

2. The linkage mapping process of claim 1, further comprising the step of:
determining a desired analyte mix and related phenotype patterns.

3. The linkage mapping process of claim 2, further comprising the step of:
selecting phenotype patterns to isolate the desired analyte mix to grow for functional testing.

4. The linkage mapping process of claim 3, further comprising the step of:
producing a genetic sequence incorporating phenotype modifications for insertion.

5. The linkage mapping process of claim 1, said organism comprising a plurality of organisms of the same species.

6. The linkage mapping process of claim 5, said organism being selected from a group consisting of: plants, algae, fungi, molds, yeasts, and bacteria.

7. The linkage mapping process of claim 6, said organism being a cannabanoid-producing plant species.

8. The linkage mapping process of claim 1, said DNA and isoform pattern dataset comprising:
a DNA pattern dataset; and
an isoform sequence dataset overlayed with said DNA pattern dataset.

9. The linkage mapping process of claim 1, prior to the step of identifying, further comprising the steps of:
creating an environmental growing condition dataset containing environmental growing condition data of said organism; and
creating a sample record dataset comprising said environmental growing condition dataset, said chemical analysis dataset and said DNA and isoform pattern dataset.

10. The linkage mapping process of claim 1, said step of correlating patterns being conducted with an artificial intelligence system.

11. The linkage mapping process of claim 11, said artificial intelligence system utilizing RBF non-linear classifier technology so as to facilitate image recognition, pattern matching and statistical analysis of pattern correlation occurrences.

12. The linkage mapping process of claim 1, said chemical analysis being conducted at an isomeric level.

13. A process for identifying genetic code for functional botanical organism attributes, the process comprising the following steps:
obtaining a genetic sample from an organism;
obtaining an analyte sample from said organism;
conducting a chemical analysis on said analyte sample using one or more of an infrared mass spectrometry machine and a high performance liquid chromatography machine so as to create a chemical analysis dataset;
conducting a genetic analysis on said genetic sample using a gene sequencer machine so as to obtain a DNA dataset and an isoform pattern dataset;
creating an environmental growing condition dataset containing growing condition data of said organism;
creating a sample record dataset comprising said chemical analysis dataset and said DNA dataset and said isoform pattern dataset and said environmental growing condition dataset;
identifying a dynamic genome sequence are of said organism;
correlating patterns of said sample record dataset; and
building a searchable pattern library based on the correlated patterns.

14. The process of claim 13, wherein the searchable pattern library is utilized to create a genetic sequence suitable for producing a desired isomer and corresponding functional attribute.

15. The process of claim 13 said organism comprising a plurality of organisms of the same species.

16. The process of claim 15, said organism being selected from a group consisting of: plants, algae, fungi, molds, yeasts, and bacteria.

17. The process of claim 16, said organism being a cannabanoid-producing plant species.

18. A process for creating an organism having a desirable functional attribute comprising the following steps:
obtaining genetic samples from a plurality of organisms of the same species;
obtaining analytes sample from said plurality of organisms;
conducting a chemical analysis on said analyte samples using one or more of an infrared mass spectrometry machine and a high performance liquid chromatography machine so as to create a chemical analysis dataset, said chemical analysis dataset comprising makeup of said organisms at an isomeric level;
conducting a genetic analysis on said genetic samples using a gene sequencer machine so as to obtain a DNA and isoform pattern dataset;
identifying a dynamic genome sequence are of said organism;
correlating patterns of said chemical analysis dataset and said DNA and isoform pattern dataset;
building a searchable pattern library based on the correlated patterns;
determining a desired analyte mix and related phenotype patterns;
selecting phenotype patterns to isolate desired analyte to grow for functional testing; and
printing a genetic sequence incorporating phenotype modifications for insertion or other methods of genetic modification.
